(19) United States
(12) Patent Application Publication
(10) Pub. No.: US 2006/0243767 A1
(43) Pub. Date: Nov. 2, 2006

(54) Magnetic pad

(76) Inventor: Michael McMillan, Caldwell, ID (US)

Correspondence Address: ROBERT L. SHAVER;DYKAS, SHAVER & NIPPER, LLP, PO BOX 877, BOISE, ID, 83701-0877, US

(21) Appl. No.: 11/120,835

(22) Filed: May 2, 2005

(51) Int. Cl. B60R 9/00

(52) U.S. Cl. 224/318; 224/327; 224/309

(57) ABSTRACT

The invention is a roof pad which is attached to the roof of a vehicle by means of magnetic attraction. The roof pad is used to protect the roof from cargo which may be placed on the roof pad. It includes a magnetic layer, which firmly attaches the pad to the roof, as well as a sealant layer in which various attachment points are embedded. The roof pad of the invention serves to protect the pad from cargo, and may include gutters, attachment points, bumper pads and restraint cords.

### BACKGROUND OF THE INVENTION

1. Field of the Invention

The present invention generally relates to vehicle roof racks and more particularly to roof racks which are held in place by magnetic attraction.

2. Background Information

There are a number of different structures which are available for attaching loads to the roof of a vehicle. These structures are generally bars which are mounted to feet or towers, with the feet or towers mounted to the gutter, or some other physical structure of the vehicle. The bars are available for a number of different attachments to be mounted to. Attachments can be mounted to the bars for carrying canoes, bicycles, skis, or other items typically carried on a roof rack. General purpose load carrying devices can also be mounted to the load bars, such as baskets, boxes, and cargo carriers which have a top and a bottom and which open and close like a suitcase.

However, sometimes what is needed for carrying a load is to have an extremely unobtrusive device which attaches to the roof and protects the roof from the sharp edges or projecting points of loads. Such a roof pad would preferably interact with factory roof racks or luggage carriers that come with the car when it is purchased. This type of roof rack would mount directly against the roof of the vehicle, and protect the vehicle roof from scratches or dents from loads being carried. Such loads could include boxes, bicycles, canoes, skis, duffle bags, suitcases, or other similar devices.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

These and other claims are achieved by the roof pad of the invention. The roof pad is designed to be mounted on the roof of a vehicle, and to adhere to the roof of the vehicle by magnetic attraction. It includes a planer pad body which includes a magnetic layer. The magnetic layer is affixed to a matrix or sealant layer with the magnetic layer providing magnetic attraction to the metal of a vehicle roof. Various design features and accessories are built into the pad body matrix layer. These may include one or more anchor points for securing the roof pad to vehicle load bars. These anchor points serve as points of attachment to the load bars, and are provided as a safety feature in case for some reason, the pad body became unattached from a vehicle roof. The anchor points to the vehicle load bars can include restraint in the form of a cable, strap, cord or other flexible line, which attaches the pad body to some portion of a load bar on the roof. It can also include a bar clasp, which can be a long tube-like device or several sections of a tube-like form, which snap in place over a load bar. The bar clasp could also be generally C-shaped in cross section, fit over a load bar, and be strapped, snapped, buckled or otherwise fixed in place around the load bar. The roof pad can include one or more load tie points, also called attachment points, configured for securing cargo to the roof pad. The cargo attachment points would preferably be formed from a bar embedded in the matrix layer of the pad body, and would typically be designed to be flush with the pad surface. The anchor points to the load bars would typically be a feature which is configured to lay flush with the surface of the pad body, but when desired it could rotate to an accessible position and be clipped into attachment with the load bars of the vehicle.

The invention may also include one or more rain gutters, which are grooves or channels formed in the pad body to facilitate the drainage of liquid from the load tie points and from the upper surface of the pad body.

Further, the invention may include one or more bumper strips, which are raised sections positioned around one or more of the peripheries of the pad body. These would typically be made of resilient material, and would help to position cargo, and keep it from sliding off the edge of the pad body.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective view of the roof pad of the invention mounted on a vehicle.

FIG. 2 is a perspective view of one embodiment of the roof pad of the invention, showing tie-down features.

FIG. 3 is a perspective view of one section of the roof pad of the invention, with layers separated.

FIG. 4 is a perspective view of the invention in which a roof pad is made of several narrow sections which fit between trim strips.

FIG. 5 is a perspective view of a narrow version of the magnetic roof pad of the invention.

FIG. 6 is a perspective view of the roof pad of the invention showing a bar clasp feature attached to load bars of the vehicle rack.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

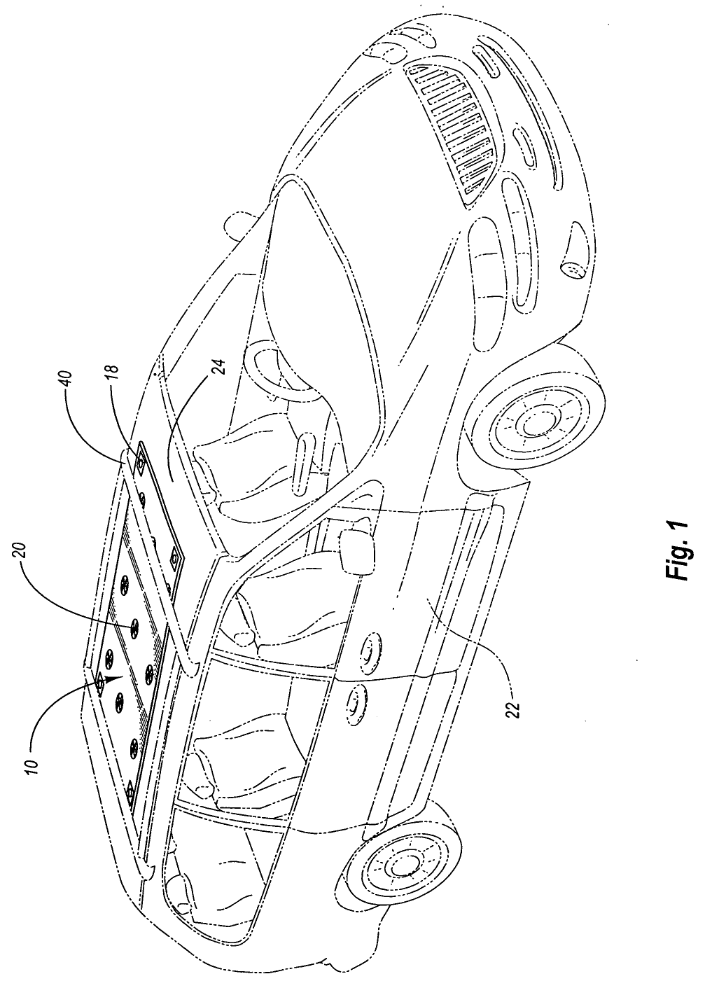

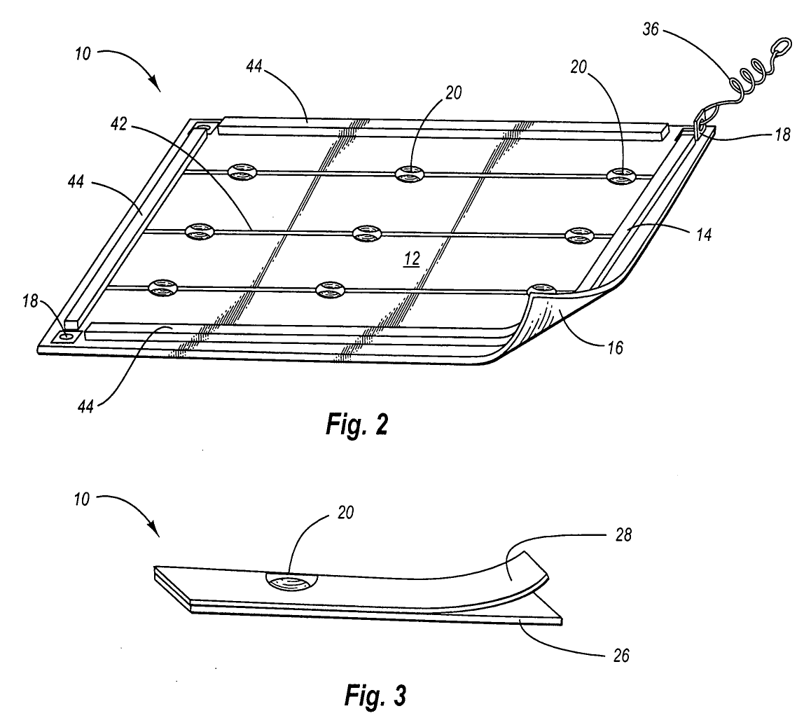

The preferred embodiment of the invention is shown in FIGS. 1-6. FIG. 1 shows the roof pad 10 of the invention mounted on an automobile 22, attached to the automobile roof 24. FIG. 1 shows anchor points 18, by which the roof pad 10 of the invention can be secured to the load bar 40 of the vehicle. The load bar 40 may be a factory roof rack, or it may be an after-market roof rack, of one of any number of configurations. The roof pad 10 is attached to the load bar 40 at the anchor points 18, by means of a restraint 36, which is shown in FIG. 2. The restraint can be a cable, a strap, a cord, or other type of connection. It would preferably have a clip or snap on one or both ends, and a lock or locks would be optional.

FIG. 2 shows additional details of the roof pad 10, including bumper strips 44, which in this case are around four sides of the pad 10. The bumper strips 44 can be attached to the surface of the pad 10, such as by adhesive, or may be molded into the material of the sealing layer. The pad 10 also includes load tie points 20, which can be placed in any number of positions or patterns on the roof pad 10. The load tie points are preferably flush with the top surface of the roof pad, and have a bar with a well under it, so that a strap or cord can be passed under the bar and then be used to secure cargo on the vehicle roof. The roof pad 10 also includes one or more rain gutters 42. These can be located between the load tie points 20, as shown in FIG. 2, or along the sides of the bumpers, or in other locations on the pad body. Shown in FIG. 2 is a pad body 12, with a first side 14 and a second side 16.

FIG. 3 shows further detail of the internal construction of the roof pad 10. The roof pad 10 includes a magnetic layer 26, bonded to a sealant layer 28. The sealant layer forms a matrix in which the load tie points 20 and the anchor points 18 are embedded and secured. The anchor points 18 are also designed to lie flush with the surface of the roof pad 10. The anchor points 18 further include a hinged portion which moves from a flush position to an upright position, as shown in the upper right corner of the roof pad in FIG. 2. With an anchor point 18 in its upright position, it is available for attachment of a restraint 36, which can be a cord or cable or strap or other type of attachment, which secures the roof pad 10 to the vehicle roof 24, as a back-up feature to the magnetic attachment.

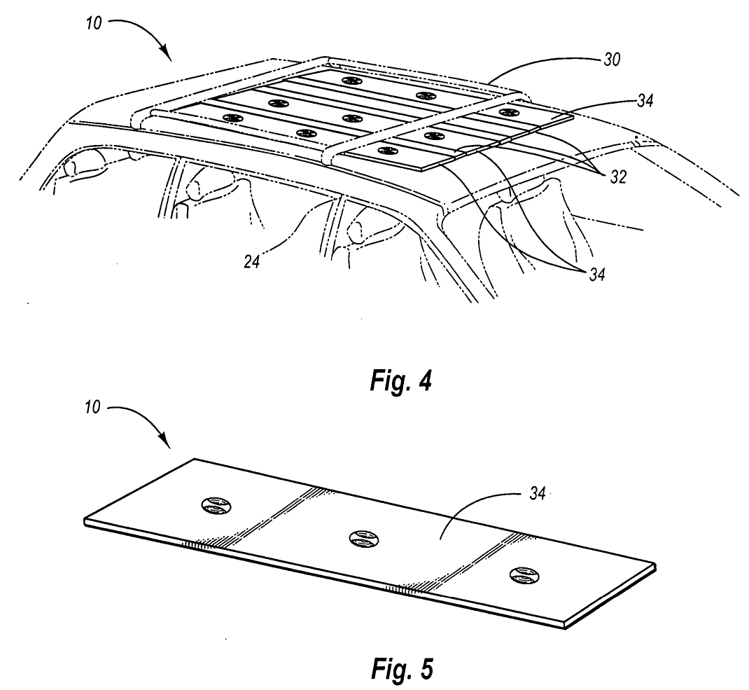

FIGS. 4 and 5 show one version of the roof pad of the invention which is configured for automobiles which have trim strips 32 placed on the automobile roof. These trim strips 32 are typically factory mounted along with a factory mounted luggage or cargo rack 30. In such an installation, the roof pad 10 of the invention would be configured in narrow sections, with multiple narrow sections 34 being used to cover the roof of the vehicle, and provide protection for the roof of the vehicle from cargo and pressure points.

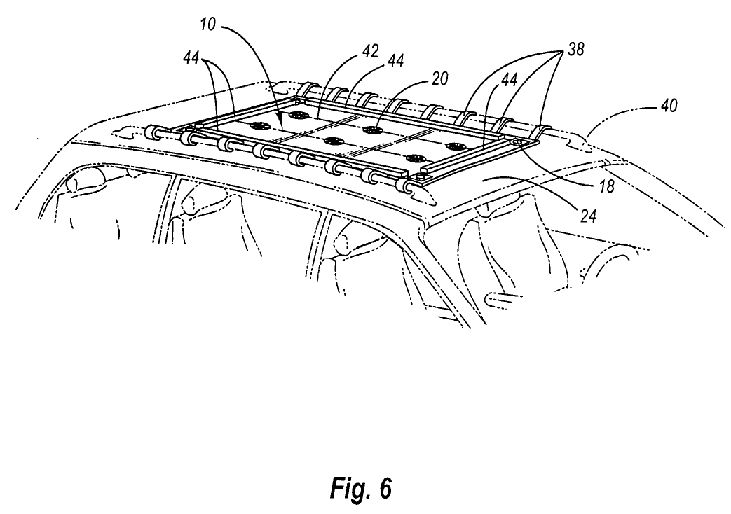

FIG. 6 shows another preferred embodiment of the invention, in which one or more bar clasps 38 are attached to the sides of the roof pad 10, and fit over the load bar 40 to secure the roof pad 10 to the vehicle. Although the bar clasps 38 is shown on two sides of the roof pad 10, other configurations of the invention could include a bar clasp 38 additionally on the transverse load bars, or solely on one load bar. The pad shown in FIG. 6 includes bumper strips 44 on all four sides, however, it is to be understood that no bumper strips may be present, or bumper strips may be present on any of the four sides of the pad. The bar clasps may take the form of a C or U shaped inverted tube, or may be in the form of C or U shaped sections, like hooks, which engage the load bars 40.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A roof pad for mounting on a vehicle, comprising:
a planar pad body, for magnetic connection to said vehicle roof, comprising a magnetic layer, and a pad body matrix layer; wherein
said planar pad body is configured to be attached to said vehicle roof by magnetic attraction, for protecting said vehicle roof from cargo items secured to said roof.

2. The roof pad of claim 1 in which said planar pad body is configured for attachment to one or more vehicle load bars.

3. The roof pad of claim 2 in which said planar pad body includes one or more anchor points for attachment to said vehicle load bars.

4. The roof pad of claim 2 in which said point for attachment to said vehicle load bars comprise one or more bar clasp.

5. The roof pad of claim 1 in which said planar pad body further comprises one or more attachment points for securing cargo to said roof pad.

6. A roof pad for mounting on a vehicle, comprising:
a planar pad body, for magnetic connection to said vehicle roof, comprising a magnetic layer, and a pad body matrix layer; and
a plurality of cargo attachment points for securing cargo to said roof pad; wherein
said planar pad body is configured to be attached to said vehicle roof by magnetic attraction, and to present said attachment points for securing said cargo to said pad body.

7. The roof pad of claim 5, in which said cargo attachment points are recessed in the pad body matrix, and flush with the exterior surface of the pad body matrix layer.

8. The roof pad of claim 6, which further comprises one or more points of attachment to said vehicle load bars, for securing said roof pad to a vehicle roof rack.

9. The roof pad of claim 9, in which said points of attachment to said load bars are rotatable from a flush position to an upright position.

10. The roof pad of claim 9, in which said points of attachment to said vehicle load bars are recessed in said pad body matrix layer.

11. The roof pad of claim 7 in which said point for attachment to said vehicle load bars comprise one or more bar clasps.

12. A roof pad for mounting on a vehicle with roof load bars, comprising:
a planar pad body, for magnetic connection to said vehicle roof, comprising a magnetic layer, and a pad body matrix layer;
a plurality of cargo attachment points for securing cargo to said roof pad;
one or more points of attachment to said vehicle load bars; wherein
said planar pad body is configured to be attached to said vehicle roof by magnetic attraction, and to present said attachment points for securing said cargo to said pad body, and with said pad configured for securing to said vehicle by attachment to said roof load bars.

13. The roof pad of claim 6, which further comprises one or more rain gutters formed in said pad body, for drainage of liquid from said attachment points and from said pad body.

14. The roof pad of claim 11 in which said point of attachment to said vehicle load bars comprise one or more bar clasps which interfit with said load bars for securing said roof pad.

15. The roof pad of claim 11, which further comprises one or more bumper strips, for positioning said load secured on said roof pad.

16. A roof pad for mounting on a vehicle with roof load bars, comprising:
a planar pad body, for magnetic connection to said vehicle roof, comprising a magnetic layer, and a pad body matrix layer;
a plurality of attachment points for securing cargo to said roof pad;
one or more points of attachment to said roof load bars;
one or more bumper strips, for use in positioning said cargo on said roof pad; wherein
said planar pad body is configured to be attached to said vehicle roof by magnetic attraction, and to present said attachment points for securing said cargo to said pad body, with said roof pad configured for securing to said vehicle by attachment to said roof load bars.

17. The roof pad of claim 16, in which said attachment points are recessed in the pad body matrix, and flush with the exterior surface of the pad body matrix layer.

18. The roof pad of claim 16 in which said point of attachment to said vehicle load bars comprise one or more bar clasps which interfit with said load bars for securing said roof pad.

19. The roof pad of claim 16 in which said bar clasps further comprise one or more passages for load bar accessories to attach to the load bars.
